(19) United States
(12) Patent Application Publication
(10) Pub. No.: US 2012/0197587 A1
(43) Pub. Date: Aug. 2, 2012

(54) VEHICLE RIDE EVALUATION

(76) Inventors: Yiu Wah Luk, Hudson, OH (US); Keith Eric Grabo, Brecksville, OH (US)

(21) Appl. No.: 13/018,597

(22) Filed: Feb. 1, 2011

(51) Int. Cl. G06F 17/18; G06F 15/00; G01P 15/00

(52) U.S. Cl. 702/141; 702/179

(57) ABSTRACT

The invention relates generally to vehicle ride evaluation and, more particularly, to a method of information sensing and transformation to assist a vehicle operator to make an informed evaluation for vehicular ride quality and a composite comprised of said vehicle and portable device secured to said vehicle for said information sensing and transformation.

### FIELD OF THE INVENTION

The invention relates generally to vehicle ride evaluation and, more particularly, to information sensing and transformation to assist a vehicle operator to make an informed evaluation for vehicular ride quality and a composite comprised of said vehicle and portable device secured to said vehicle for said information sensing and transformation.

### BACKGROUND OF THE INVENTION

A vehicular operator's perception of vehicular ride quality, and particularly vehicular comparative ride quality, may be desirable for operation of a vehicle under various conditions. Reducing such perception to numerical values for an objective test may be advantageous to the vehicle operator.

Ride quality for a vehicle may be a result of many contributing factors including a combination of vehicular weight and suspension, tire selection, tire inflation pressure, tire tread wear, the vehicle's rate of travel, or speed, as well as road conditions over which the vehicle travels.

Historically, various systems have been devised and implemented to assist in providing a vehicle operator with relevant vehicle information for maintenance purposes, including vehicle self-diagnostic services to provide the vehicle owner/operator or a repair technician access to a state of health information of various vehicle sub-systems. Access to the diagnostic information for repair purposes is an effective tool and has improved the efficiency of making predictive or needed vehicle repairs. While information from vehicle systems is useful for repair purposes, there remains a desire for a relatively simple and objective method of evaluation of perceived vehicular ride quality.

### SUMMARY OF THE INVENTION

In accordance with this invention, a method of determining an evaluation of ride quality of a wheeled vehicle includes the steps of:

(A) providing a portable device (e.g. instrument such as, for example, a smart phone) containing:
(1) a built-in tri-axial accelerometer capable of sensing and measuring the device's individual accelerations in each of tri-axial fore-aft, lateral and vertical directions, and,
(2) conversion analytical software capable of calculating and displaying the Root-Mean-Square (RMS) value of accelerations acquired in each of said three tri-axial directions and a summation of said tri-axial accelerations (e.g. by means of vector sum analysis);

(B) operating said wheeled vehicle over the ground at a constant rate of vehicular speed to thereby create a moving wheeled vehicle,

wherein the wheels of said wheeled vehicle are comprised of rigid wheels with circumferential ground-contacting rubber tires;

wherein said device is securely attached to said wheeled vehicle in a manner that sensed tri-axial directional accelerations by said device are tri-axial directional accelerations of the moving vehicle,

(C) activating said device secured to said wheeled vehicle to:
(1) sense (e.g. by the built-in accelerometer) and measure the moving wheeled vehicle's individual accelerations in each of said tri-axial fore-aft, lateral and vertical directions, and,
(2) calculate and display the Root-Mean-Square (RMS) values (e.g. by the analytical software) of accelerations acquired in each of said three tri-axial directions, and
(3) calculate and display a summation (e.g. vector summation by the analytical software) of said tri-axial accelerations.

In a further embodiment of the invention, a step of communicating the processed information to at least one vehicle service provider located externally to the vehicle is provided.

In another embodiment of the invention, the step of activating said analytical software utilized by the portable device is initiated automatically (e.g. in real time, namely, as the information is being generated) by sensing said information (e.g. sensing said accelerometer generated information) by said portable device.

According to a further embodiment of the invention, said displayed summation of said accelerometer information is determined by calculating the Root-Mean-Square (RMS) values of the accelerations in each of said three directions, (namely the fore-aft or x direction, the lateral or y direction and the vertical, or z direction) and combining said RMS values of said accelerations by vector summation by said analytical software to yield an individual numerical value. In such case, a higher numerical value represents a greater resultant summation of said collective accelerations indicating a higher vibration level for the vehicle which would normally represent a less comfortable vehicular ride. A lower numerical value represents a lower resultant summation of said collective accelerations indicating a lower vibration level for the vehicle which would normally represent a more comfortable vehicular ride.

In practice, such embodiment may be used, for example, to compare the vehicular ride generated by one set of tires on an associated vehicle, or other vehicular ride generating appurtenance, by another set of tires on the same vehicle. It can also be used to compare the vehicular ride experienced by two or more vehicles. Another usage may be to detect irregular tire and wheel alignments and balancing on the vehicle itself as well as other vehicular design or configuration inconsistencies.

In additional accordance with this invention, a composite is provided comprised of a wheeled vehicle and a portable device (e.g. instrument such as, for example, a smart phone) secured to said wheeled vehicle;

wherein the wheels of said wheeled vehicle are comprised of rigid wheels with circumferential ground-contacting rubber tires;

wherein said portable device contains:

(A) a built-in tri-axial accelerometer capable of sensing and measuring the secured device's, and thereby the wheeled vehicle's, individual accelerations in each of tri-axial fore-aft, lateral and vertical directions, when the wheeled vehicle is moving on the ground, and,

(B) conversion analytical software capable of calculating and displaying the Root-Mean-Square (RMS) value of accelerations acquired in each of said three tri-axial directions and a summation of said tri-axial accelerations (e.g. by means of vector sum analysis).

### BRIEF DESCRIPTION OF THE DRAWINGS

The invention will be described by way of example and with reference to the accompanying drawings in which:

FIG. 1 depicts a horizontal outline of a vehicle with an included a portable device in the form of a smart phone,

FIG. 2 depicts a vertical cross-section of a vehicle with a portable device such as a smart phone attached to its dashboard and

FIG. 3 depicts a display screen on said device (e.g. smart phone) with graphical plots of calculated RMS values for each of the fore-aft, lateral and vertical direction accelerations of the vehicle and a summation of said accelerations.

### DETAILED DESCRIPTION OF THE INVENTION

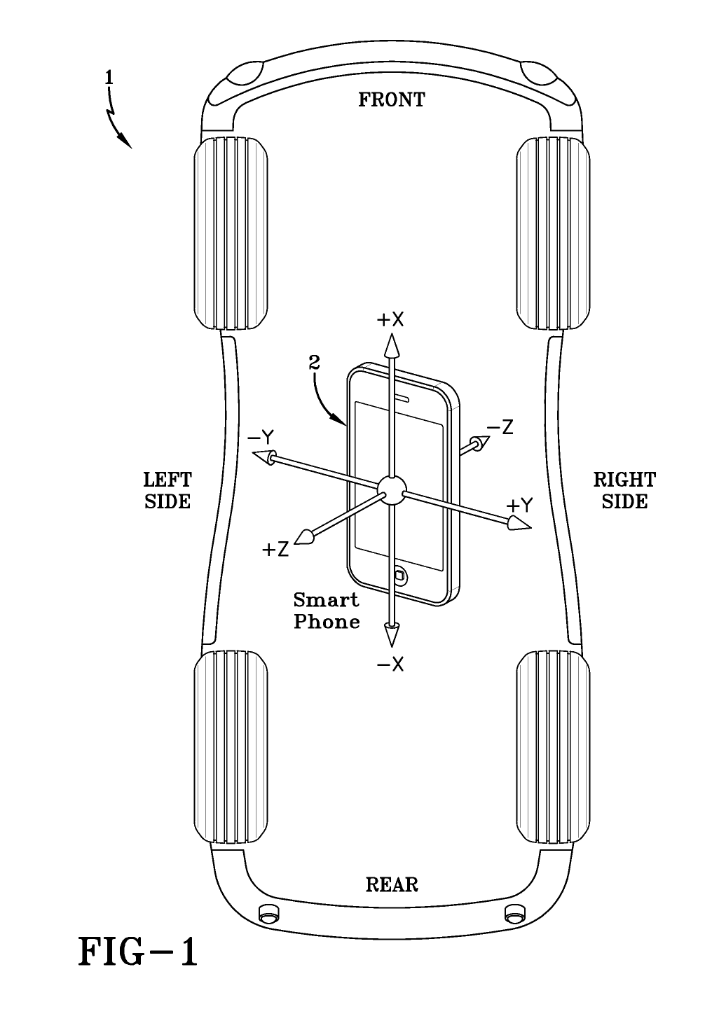

Referring to FIG. 1, a horizontal outline of a vehicle (1) is presented with on overlay of a portable device (2) in a form of a smart phone which contains a built-in tri-axial accelerometer capable of sensing accelerations in three axial directions, namely in a fore-aft direction represented by the x axis, in a lateral direction represented by the y axis and in a vertical direction represented by the z axis. Representative of such smart phone is, for example, an iPhone™ from Apple.

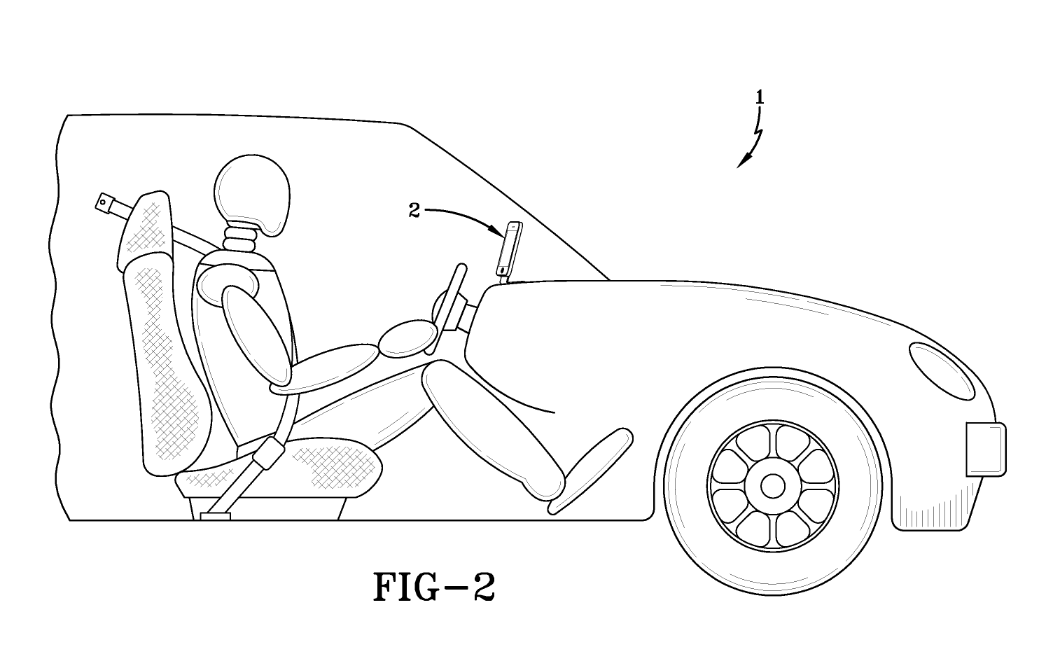

Referring to FIG. 2, a partial vertical outline of the vehicle (1) is presented with the smart phone (2) rigidly attached to the dashboard of the vehicle which can be observed by the driver (3) of the vehicle (1).

With the vehicle (1) moving as being driven by the vehicle driver (3), the tri-axial accelerometer of the rigidly mounted portable device, namely the smart phone (2), senses accelerations in three axial directions, including positive and negative accelerations, of movement of the vehicle (1), namely accelerations in the fore-aft directional movement of the vehicle (1) as an x axis, accelerations in the lateral directional movement of the vehicle (1) as a y axis and in the vertical directional movement of the vehicle (1) as a z axis.

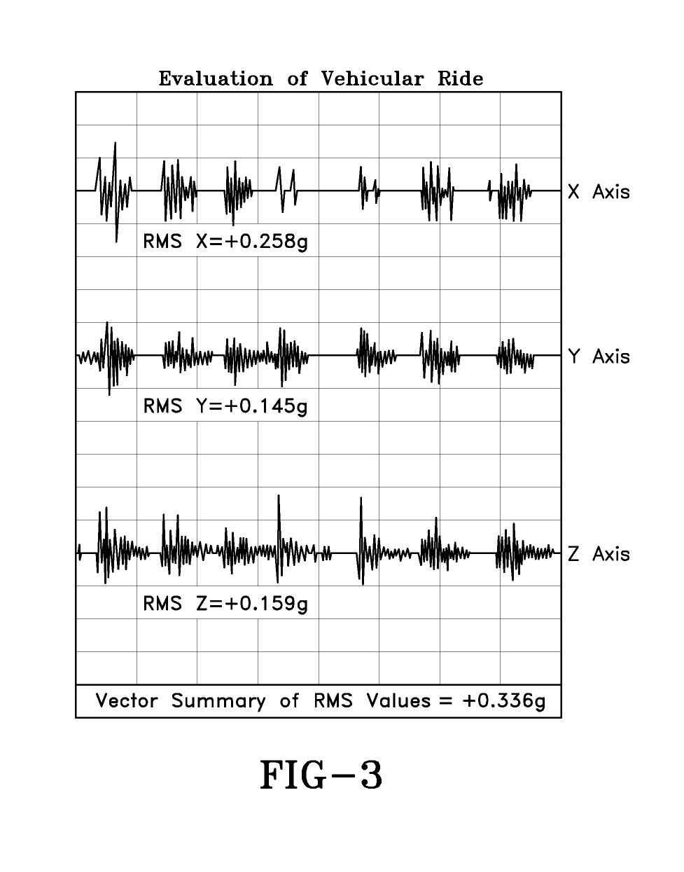

Referring to FIG. 3, the screen on the device (e.g. instrument such as for example a iPhone™) displays a graphical plot of each of the RMS calculated directional accelerations (as a feature of the an analytical software contained in the instrument) of the vehicle, namely the fore-aft acceleration represented in FIG. 3 on an x axis, the lateral acceleration represented in FIG. 3 on a y axis and the vertical acceleration represented in FIG. 3 on a z axis. In FIG. 3, for illustrative purposes, an exemplary 0.336 g (where 1 g=1 gravitational force) is shown as a vector sum (a vector summation as a feature, or capability, of the analytical software contained in the instrument) of the individual exemplary calculated RMS plotted values for the x, y and z data versus time (0.258 g, 0.145 g and 0.159 g, respectively) sensed by the built-in accelerometer and calculated by the analytical software contained in the portable device, or instrument.

Conversion analytical software in a form of a software application (which may be referred to as an “App”) is downloadable, for example, from the internet to the said iPhone™, Representative of such downloadable App is, for example, an App identified as “Vibration” believed to be a product of Diffraction Limited Design LLC.

To be useful, the tri-axial acceleration information must be quickly sensed and computed in almost real-time by the portable device (2), (the smart phone which contains the built-in accelerometer) to adequately assist the user (e.g. user in the vehicle) in evaluating vehicular ride quality.

The user (e.g. vehicle operator or passenger) within the vehicle (1) may bring said portable device (2) to the vehicle (1) and rigidly mount the device (2) on or within the vehicle (1) which, if desired, may also include a global positioning monitor (e.g. GPS monitor) and which may optionally be used to access vehicular driving direction or position of the vehicle (1) itself. Said device (2) may also have incorporated therein a voice command capability whereby which may allow a vehicle operator to actuate and control the operation of the device (2) hands-free. Such portable device (2) may be further equipped with a commercially available software application program (an App) that can activate the device (2) automatically by a remotely transmitted command signal.

The smart phone (2), with its built-in tri-axial accelerometer and aforesaid appropriate App software, is calibrated and activated. It is mounted securely to an appropriate location such as, for example, the dashboard or on the top or the steering wheel of the vehicle (1) inside the vehicle (1) where the operator or passenger can feel/experience the vehicular ride quality. The drive of the vehicle (1) can drive the vehicle (1) at a fixed speed over a surface such as a road surface. An operator will start the data acquisition and the device (2) will acquire the tri-axial acceleration information, or data, experienced by the moving vehicle (1).

The software (the App) programmed into the smart phone (2) then analyzes the data, performs necessary calculation of the data and visually presents the result in a useful form on the smart phone (2) screen for the operator/passenger to read. Information displayed by the software may include graphical presentations of the amplitudes of each of the x, y and z axis directions of the respective accelerations versus time. The software calculates and displays the individual Root-Mean-Square (RMS) values for each of the three acceleration directions, namely the fore-aft, lateral and vertical directions. Then, the RMS values of the three acceleration directions are combined by the software as the mean of the vector sum to yield and display a single numerical value. This final combined mean RMS value can be used to evaluate the ride quality of the vehicle which might be ultimately presented in terms of, for example, a comfort index (e.g. vehicular ride quality or comfort). A higher RMS summed value is indicative of a higher vibration level experienced by the vehicle which may be less desirable for a comfortable ride. A lower RMS summed value is indicative of a lower vibration level experienced by the vehicle which may be more desirable for a more comfortable ride.

The operator or passenger may then evaluate the vehicular ride quality by reading the RMS summed value generated by the smart phone.

Relevant and useful information (e.g. the aforesaid RMS summed value) concerning the vehicular ride evaluation may be communicated within the vehicle to an operator, user or passenger and/or, if desired, communicated, for example, to a vehicle or tire supplier or manufacturer to review the generated data and take whatever action might be deemed appropriate.

By such communicative methodology, the operator/passenger/user may more conveniently demonstrate or relate objectively the quality of the vehicular ride instead of solely subjectively and verbally describing the vehicular ride which might possibly not be entirely relevant to the vehicular ride quality itself if, for example, the ride quality should involve an excessive vibration issue.

From the forgoing, it will be appreciated that methodology and system of this invention provides real-time convenient and useful information to customer/user of the vehicle by means of a device such as a portable smart phone (e.g. iPhone™) which may be located within the vehicle itself.

Additionally, by activating analytical software utilized by the portable device, namely the smart phone, vehicular ride performance might be evaluated objectively by using instrumentation, ride performance of two or more vehicles or ride quality of an individual vehicle with two or more sets of tires in a more acceptable/precise manner.

In practice the RMS (root-mean-square) values are typically mathematical values computed by taking the square root of the average (mean) of the squares of a set of randomly varying quantities observed at regular intervals during a cycle which is a function of the software used to calculate the RMS values (exemplary of such methodology might be a visualization of an alternating electrical current). It is considered that, for many purposes, an RMS value is the best measure of the effective or typical value of the phenomenon being observed.

In practice, when a wheeled vehicle is stationary, the vibration energy, evidenced by the aforesaid tri-axial directional accelerations, is zero and ride comfort is therefore considered as being at its maximum performance, or comfort, level. As the wheeled vehicle moves, its tires and vehicle suspension system work to tend to increase the vibration level (e.g. work to increase the said tri-axial directional accelerations as being evidentiary of the increased vibration level of the wheeled vehicle as it travels over road irregularities) and it is usually desired for the vehicle's tires, wheels and suspension system work together to reduce vibration energy generated from disturbances which may occur in the road surface over which the wheeled vehicle travels to promote a smoother, more comfortable ride.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of determining an evaluation of ride quality of a wheeled vehicle includes the steps of:
(A) providing a portable device containing:
(1) a built-in tri-axial accelerometer capable of sensing and measuring the device's individual accelerations in each of tri-axial fore-aft, lateral and vertical directions, and,
(2) conversion analytical software capable of calculating and displaying the Root-Mean-Square (RMS) value of accelerations acquired in each of said three tri-axial directions and a summation of said tri-axial accelerations;
(B) operating said wheeled vehicle over the ground at a constant rate of vehicular speed to thereby create a moving wheeled vehicle,
wherein the wheels of said wheeled vehicle are comprised of rigid wheels with circumferential ground-contacting rubber tires;
wherein said device is securely attached to said wheeled vehicle in a manner that sensed tri-axial directional accelerations by said device are tri-axial directional accelerations of the moving vehicle,
(C) activating said device secured to said moving wheeled vehicle to:
(1) sense and measure the moving wheeled vehicle's individual accelerations in each of said tri-axial fore-aft, lateral and vertical directions, and,
(2) calculate and display the Root-Mean-Square (RMS) values of accelerations acquired in each of said three tri-axial directions, and
(3) calculate and display a summation of said tri-axial accelerations.

2. A composite comprised of a wheeled vehicle and a portable device secured to said wheeled vehicle;
wherein the wheels of said wheeled vehicle are comprised of rigid wheels with circumferential ground-contacting rubber tires;
wherein said portable device contains:
(1) a built-in tri-axial accelerometer capable of sensing and measuring the secured device's, and thereby the wheeled vehicle's, individual accelerations in each of tri-axial fore-aft, lateral and vertical directions, when the wheeled vehicle is moving on the ground, and,
(2) conversion analytical software capable of calculating and displaying the Root-Mean-Square (RMS) value of accelerations acquired in each of said three tri-axial directions and a summation of said tri-axial accelerations.
